(19) United States
(12) Patent Application Publication
(10) Pub. No.: US 2026/0112557 A1
(43) Pub. Date: Apr. 23, 2026

(54) CIRCUIT BREAKER

(71) Applicant: GE INFRASTRUCTURE TECHNOLOGY LLC, Greenville, SC (US)

(72) Inventors: Ludovic DARLES, Villeurbanne (FR); Cyril GRÉGOIRE, Villeurbanne (FR); Dan Lucius PENACHE, Villeurbanne (FR); Marceau CHABAS, Villeurbanne (FR)

(21) Appl. No.: 19/347,821

(22) Filed: Oct. 2, 2025

(30) Foreign Application Priority Data
Oct. 22, 2024 (EP) 24208138.8

(51) Int. Cl. H01H 33/70; H01H 33/56

(52) U.S. Cl. CPC H01H 33/7015; H01H 33/56

(57) ABSTRACT

A circuit breaker having a first electrical contact and a second electrical contact that are arranged movably relative to one another in a movement direction. Inside the first electrical contact, an interior hollow space is provided that is in fluidic connection with at least one gas flow opening provided in the area of a distal end of first electrical contact. The interior hollow space is in fluidic connection with a gas flow creating device. During a relative movement of the first electrical contact and the second electrical contact in movement direction, a gas flow may be created through the interior hollow space and the at least one gas flow opening for cooling at least the distal end of first electrical contact in order to avoid creation of an electrical arc between the two electrical contacts or at least terminate the electrical arc as quickly as possible.

### TECHNICAL FIELD

The invention relates to a circuit breaker, particularly a high voltage circuit breaker, providing an improved arc cooling and/or arc extinction.

### BACKGROUND

In the field of circuit breaker technology it is known to provide means and devices for cooling or cutting-off an electrical arc is created when two electrical contacts of the circuit breaker are moved away from one another in order to interrupt an electrical current flowing between the two electrical contacts in the contact position (conducting condition). Such an arc creation is undesired, because the current flowing between the electrical contacts continues until the electrical arc extinguishes. Moreover, such an electrical arc stresses the electrical contacts and can reduce the lifetime of the circuit breaker.

In order to cool and extinguish the electrical arc, it is known to use gas, particularly sulfur hexafluoride, for cooling and cutting the arc off. Although the gas cooling methods used up to date are suitable, it is desired to improve arc cooling in order to counteract arc creation and/or shorten the lifetime of the arc, i.e. the duration starting with the creation of the arc until the arc extinguishes.

### SUMMARY

Starting therefrom, the object of the present invention is to improve the cooling and/or cut-off of an electrical arc formed in a circuit breaker during interruption of current flowing between two electrical contacts of the circuit breaker.

This object is solved by a circuit breaker according to claim 1.

The circuit breaker according to the invention compresses a first electrical contact and a second electrical contact. The first electrical contact has an outer contact surface, particularly in the region of an outer circumferential surface. The outer contact surface can be ring-shaped and/or can have the form of a cylindrical circumferential surface. The second electrical contact has an inner contact surface configured to abut against the outer contact surface when the two electrical contacts are in a contact position. The first contact can be a male contact and the second contact can be a female contact.

The first and second electrical contacts can be moved relative to one another in a movement direction. They can be moved relative to one another between the contact position and a blocking position. In the blocking position, the two electrical contacts are arranged with distance to one another, which is sufficient to avoid formation of an electrical arc between the two contacts.

In the contact position the outer contact surface of the first electrical contact and the inner contact surface of the second electrical contact abut against one another so that a reliable electrical connection is established. Consequently, an electrical current can flow between the two electrical contacts. When the two electrical contacts move away from one another out of the contact position, an electrical arc may be created between the first electrical contact and the second electrical contact as long as the distance between the two electrical contacts is insufficient to avoid electrical breakthrough.

In order to cool and/or cut-off such an electrical arc, the circuit breaker is configured to create a gas flow in the region where the two electrical contacts are in mechanical contact and/or are arranged close to one another. The circuit breaker can also be denoted as arc-blast circuit breaker. For conveying the gas to a location, where an arc can be created, the first electrical contact is provided with an interior hollow space that can be formed by at least one chamber and/or at least one channel inside the first electrical contact. This interior hollow space is fluidically connected with at least one gas flow opening of the first electrical contact. The gas flow opening is provided at a distal end or tip of the first electrical contact. The distal end of the first electrical contact is the end that is located closer to the second electrical contact if the two contacts are in the blocking position.

The gas flow creating device is fluidically connected with the interior hollow space and/or can at least partly comprise the interior hollow space. Thus, a gas flow created by the gas flow creating device can flow from the interior hollow space through the at least one gas flow opening out of the first electrical contact or else through the at least one gas flow opening into the interior hollow space of the first electrical contact depending on whether the gas flow creating device is configured to blow out gas out of the at least one gas flow opening or to suck gas into the at least one gas flow opening.

Particularly, the gas flow creating device can be configured to create the gas flow as soon as the two electrical contacts are moved out of the contact position or at least in a phase when the mechanical contact between the first electrical contact and the second electrical contact is terminated.

In an embodiment the gas flow is exclusively or at least in part produced by the pressure increase inside a circuit breaker housing of the circuit breaker, when the electrical arc is created. Specifically, due to the electrical arc the temperature rises which in turn increases the pressure of the gas provided inside the circuit breaker housing. Preferably, the gas flow creating device comprises a gas compartment that is fluidically connected to the at least one gas flow opening via the interior hollow space and/or the gas compartment is part of the interior hollow space. Particularly, the gas compartment is fluidically separated from the surrounding volume inside the circuit breaker housing and can be exclusively fluidically connected to the at least one gas flow opening (e.g. directly as part of the interior hollow space or indirectly via the interior hollow space). For example, the gas compartment can be realized by a gas container fluidically connected to the interior hollow space or can be integral part of the first electrical contact.

The temperature and the pressure may vary in accordance with the electrical current (e.g. alternating current AC) flowing between the electrical contacts. Thereby gas can be pressed into the gas compartment when the pressure increases (increasing electrical current) and can exit the gas compartment again, when the pressure decreases (decreasing electrical current). Using this effect, the gas compartment does not require displaceable of moveable pressure producing components, such as a piston. However, such a pressure producing component can be additionally provided.

It has to be noted that the gas flow creating device can be additionally configured to create a gas flow from the second electrical contact toward and/or around the first electrical contact.

The temperature increase due to an electrical arc also increases the gas temperature inside the gas compartment, so that the pressure inside the gas compartment exceeds the pressure outside the gas compartment, but inside the circuit breaker housing. Consequently, a gas flow is produced out of the gas compartment towards and out of the at least one gas flow opening.

The interior volume of the gas compartment (compartment volume) is smaller than the interior volume of the free space inside the circuit breaker housing (free housing volume). The free housing volume is the interior volume of the circuit breaker housing where the gas is present. The free housing volume can be defined as the total interior volume of the circuit breaker housing minus the total volume of all parts arranged inside the circuit breaker housing.

Particularly the compartment volume can be maximum 50% or maximum 40% or maximum 30% or maximum 20% or maximum 10% of the free housing volume. For example, the compartment volume can be maximum 0.30 liter or maximum 0.20 liter or maximum 0.15 liter and may be approximately 0.1 liter.

As an option, an additional gas flow can be created around the first electrical contact, particularly by blowing out gas from the second electrical contact or by sucking gas into the second electrical contact.

Providing a gas flow inside the first electrical contact, an improved cooling of the first electrical contact, particularly in the region of the outer contact surface, can be achieved. The gas flow through the at least one gas flow opening of the first electrical contact can also improve the gas flow along the first electrical contact in that an improved detachment of the gas flow from the surface of the first contact (particularly in the region of the at least one gas flow opening) can be achieved. Also, a shock wave mitigation can be improved.

The used gas can be denoted as cut-off gas or insulating media. For example, one of the following gases or gas mixtures can be used:
sulfur hexafluoride (SF₆),
carbon dioxide (CO₂),
Nitrogen (N₂)
a mixture of carbon dioxide(CO₂), dioxygen (O₂) and a fluoronitrile (e.g. C₄—PFN),
a mixture of carbon dioxide (CO₂) and fluoronitrile (e.g. C₄—PFN),
a mixture of carbon dioxide(CO₂) and dioxygen (O₂),
a mixture of carbon dioxide(CO₂), dioxygen (O₂) and fluoroketone (e.g. C₅—PFK),
a mixture of carbon dioxide(CO₂) and fluoroketone (e.g. C₅—PFK),
a mixture of nitrogen (N₂) and fluoronitrile (e.g. C₄—PFN), or
a mixture of nitrogen (N₂) and dioxygen (O₂)
   The gas can be provided to the gas flow creating device. Particularly, it can be present in a housing interior of the circuit breaker and thus in the atmosphere surrounding the electrical contacts.

It is advantageous if the first electrical contact forms a pin or male contact and/or the second electrical contact forms a socket or female contact. The electrical connection between the pin and the socket can be established and interrupted by a linear or non-linear (e.g. pivoting) movement in moving direction. In a preferred embodiment, the first electrical contact extends along a first center axis and the second electrical contact extends along a second center axis. The outer contact surface of the first contact can extend concentrically around the first contact axis. The two center axes are orientated parallel to the moving direction. In the contact position between the first electrical contact and the second electrical contact, the first center axis and the second center axis are aligned so that they coincide. In at least one embodiment the first and second center axes are permanently aligned so that they coincide.

In an embodiment, the first electrical contact may comprise one single gas flow opening. The gas flow opening can be a center opening through which the first center axis extends. In a modified embodiment, one or more additional gas flow openings may be provided in addition to the center opening.

In at least one embodiment, at least one gas flow opening can be provided that is arranged with distance to the first center axis. Such a gas flow opening can be denoted as offset opening. At least one offset opening can be provided in addition or as an alternative to the center opening. The orientation of an opening axis of the at least one offset opening is preferably inclined relative to the first center axis.

If more than one gas flow opening is provided, two or more of the present gas flow openings may have equal or different cross-sections. The orientation of the opening axes of the multiple gas flow openings can be parallel or can be different from one another. For example, at least one opening axis may be orientated parallel to the first center axis, wherein at least one opening axis may be inclined relative to the first center axis. At least some of the opening axes being inclined relative to the first center axis can have equal absolute inclination angle values and can be arranged with distance to each other in circumferential direction around the first center axis.

The number of gas flow openings can vary. They can be arranged in a regular or irregular pattern and can optionally form a showerhead-like pattern.

As already mentioned above, the gas flow creating device may be configured to create a pressure inside the interior hollow space, which is higher or lower than the pressure in the atmosphere surrounding the first electrical contact and the second electrical contact. In doing so, a gas flow from the interior hollow space out of the at least one gas flow opening or through the at least one gas flow opening into the interior hollow space can be created respectively.

In an alternative embodiment, the gas flow creating device comprises a piston arranged in a cylinder chamber. A wall of the cylinder chamber, which is in contact with the piston and the piston are arranged movably relative to each other. Depending on the movement direction of the piston in upstream or downstream direction relative to the at least one gas flow opening, a desired flow direction of the gas flow out of the gas flow opening or into the gas flow opening can be created. Preferably, the piston and the wall of the cylinder chamber are arranged to be movable relative to one another in the movement direction.

In an embodiment, at least one section of the interior hollow space inside the first electrical contact forms the cylinder chamber. In a modified embodiment, the cylinder chamber can be arranged outside the interior hollow space, particularly in a cylinder housing. In this case, the cylinder chamber is fluidically connected with the interior hollow space. Preferably, the cylinder housing is attached to the first electrical contact, whereby the cylinder housing and the first electrical contact are preferably immovably arranged relative to one another.

The wall limiting the cylinder chamber being in contact with the piston and/or a circumferential contact wall or ring of the piston can be provided with a friction-reducing layer or can consist of low-friction material.

It is advantageous if a coupling arrangement is provided that is configured to movably couple at least two movable components of the circuit breaker with one another. The coupling is configured to cause a movement of at least one of the coupled components if another component of the coupled components is moved. The movement is particularly initiated by a movement of at least one of the electrical contacts in movement direction and transferred by means of the coupling arrangement to one of the other movable, coupled components. Particularly, the at least two movable components, which are coupled by means of the coupling arrangement, are selected from the group of the following components: the first electrical contact, the second electrical contact and a component of the gas flow creating device, particularly the piston and/or the cylinder housing.

The coupling arrangement can be configured to cause at least one of the following movements relative to a circuit breaker housing:
The piston is moved while the cylinder chamber stands still if the first and/or second electrical contact is moved in movement direction;
The piston stands still and the cylinder chamber is moved if the first and/or second electrical contact is moved in movement direction;
The first electrical contact and the second electrical contact are moved in opposite directions parallel to the movement direction;
The first electrical contact or the second electrical contact stands still if the respective other electrical contact is moved in movement direction.

### BRIEF DESCRIPTION OF THE DRAWINGS

Preferred embodiments are also disclosed in the dependent claims, the description and the drawings. In the following, preferred embodiments of the invention are explained in detail based on the attached drawings. The drawings show:

FIG. 1 an embodiment of a circuit breaker in a schematic block-diagram-like illustration, having a first electrical contact and a second electrical contact arranged in a contact position,

FIG. 2 the embodiment of the circuit breaker according to FIG. 1, wherein the first electrical contact and the second electrical contact are in a blocking position,

FIG. 3 a modification of the embodiment according to FIGS. 1 and 2, wherein first electrical contact and the second electrical contact are in the blocking position as in FIG. 2,

FIG. 4 an embodiment of a circuit breaker in a schematic block diagram illustration, wherein the first electrical contact and the second electrical contact are in the contact position,

FIG. 5 the embodiment of the circuit breaker of FIG. 4, wherein the first electrical contact and the second electrical contact are in the blocking position,

FIGS. 6 to 8 one embodiment of a circuit breaker respectively in schematic block diagram illustration, wherein the first electrical contact and the second electrical contact are in the contact position, in each case, and

FIG. 9 another embodiment of a circuit breaker in schematic block diagram illustration, wherein the first electrical contact and the second electrical contact are in the blocking position.

### DETAILED DESCRIPTION

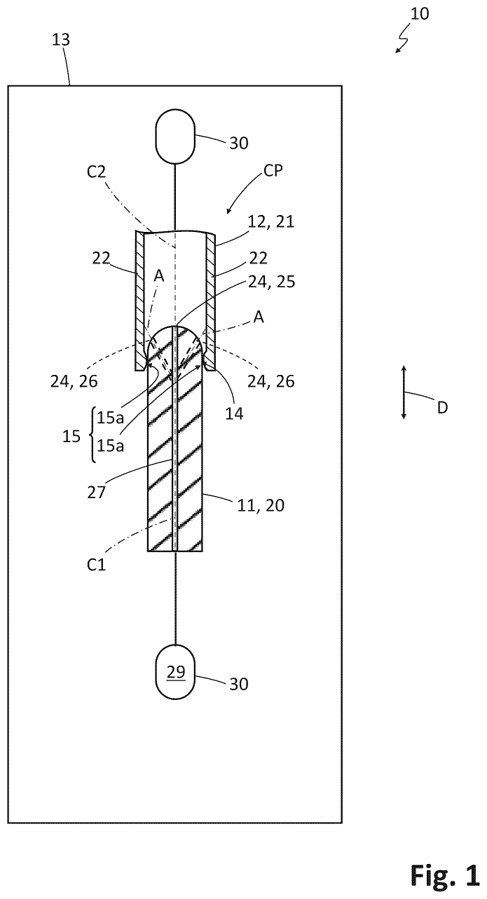

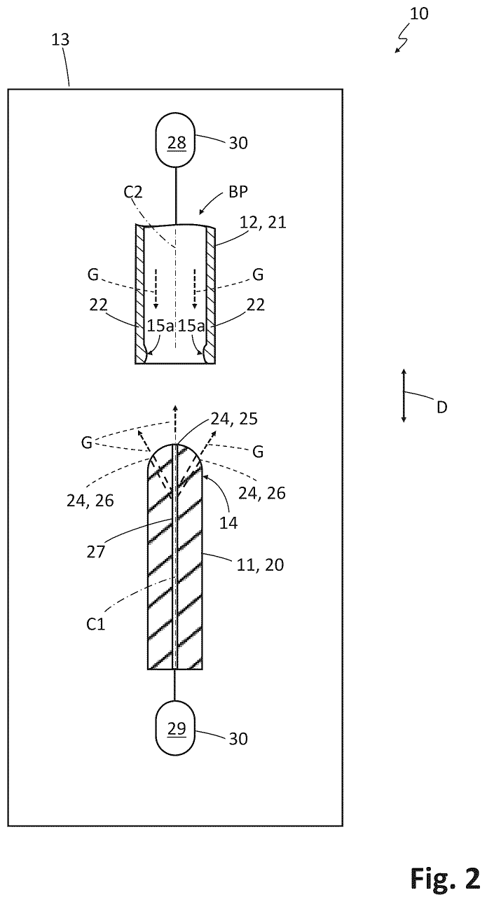

In FIGS. 1 and 2 a first embodiment of a circuit breaker 10 is illustrated. The circuit breaker 10 is configured to establish or interrupt an electrical connection between a first electrical contact 11 and a second electrical contact 12. For this purpose, the two electrical contacts 11, 12 can be moved relative to one another in a movement direction D. The relative movement in movement direction D is preferably a linear movement as is it the case in the illustrated preferred embodiments. In a not illustrated modified embodiment, the relative movement of the two electrical contacts 11, 12 could also be a pivot movement.

According to the example, the two electrical contacts 11, 12 are arranged inside a circuit breaker housing 13. The circuit breaker housing 13 is only shown in a highly schematical manner. The interior of circuit breaker housing 13 can be gas-tight relative to the environment for providing a gas atmosphere of a cut-off gas in inside the circuit breaker housing 13.

The first electrical contact 11 has an outer contact surface 14 and the second electrical contact 12 has an inner contact surface 15. The first and second contact surfaces 14, 15 are configured to cooperate with one another for establishing a mechanical and electrical contact between the first electrical contact 11 and the second electrical contact 12, if the two electrical contacts 11, 12 are in a contact position CP. The contact position CP is illustrated in FIG. 1. In the contact position CP the inner contact surface 15 is in mechanical contact with the outer contact surface 14, so that an electrical connection is established between the first electrical contact 11 and the second electrical contact 12.

As apparent from FIGS. 1 and 2, the first electrical contact 11 extends along a first center axis C1 and the second electrical contact 12 extends along a second center axis C2. The two center axes C1, C2 are aligned and coincide in the contact position CP. The center axes C1, C2 are orientated parallel to the movement direction D.

The inner contact surface 15 is arranged coaxially around the second center axis C2 and faces the second center axis C2. Preferably, inner contact surface 15 of second electrical contact 12 is separated into at least two inner contact surface sections 15a together forming the inner contact surface 15. The inner contact surface sections 15a can distanced from one another in circumferential direction around the second center axis C2, e.g. two or more inner contact surface sections 15a can be uniformly distributed in circumferential direction. Each inner contact surface section 15a can be domed toward second center axis C2 and/or can be convex with view from the second center axis C2.

The outer contact surface 14 is arranged coaxially around the first center axis C1 and faces away from the first center axis C1. It can be continuous in circumferential direction around the first center axis C1, e.g. ring shaped. The outer contact surface 14 can have the shape of a cylindrical or conical circumferential surface.

In the preferred embodiments, the first electrical contact 11 is realized in form of a male contact, particularly a pin 20. The second electrical contact 12 is configured to cooperate with pin 20, so that in the contact position CP in which the inner contact surface 15 of the second electrical contact 12 surrounds at least a portion of the pin 20 and abuts against the assigned outer contact surface 15 of pin 20.

In the preferred embodiments, the second electrical contact 12 is realized as female contact that may form a bushing or socket 21. Please note that the socket 21 is illustrated in the drawings only highly schematically and may comprise two or more elastically deflectable contact elements 22 that can be elastically deflected from the second center axis C2 when pin 20 is inserted inside the socket 21. Each contact element 22 can have one inner contact surface section 15a. In the illustrated embodiments two contact elements 22 are shown by way of example that can be arranged opposite one another around second center axis C2. More than two contact elements 22 can be arranged around second center axis C2 alternatively.

The two electrical contacts 11, 12 can be moved relative to one another in movement direction D between the contact position CP (FIG. 1) and a blocking position BP shown in FIG. 2. In the blocking position BP, the first electrical contact 11 and the second electrical contact 12 are arranged with distance to one another, so that the electrical connection between the first electrical contact 11 and the second electrical contact 12 is interrupted or can be interrupted and particularly will not reestablish unintentionally when a predefined electrical potential difference occurs between the first electrical contact 11 and the second electrical contact 12. The distance between the first electrical contact 11 and the second electrical contact 12 in the blocking position BP can also be denoted as insulating distance.

The relative movement between the two electrical contacts 11, 12 in movement direction D can be realized in that only one of the two electrical contacts 11, 12 moves relative to the circuit breaker housing 13, or in that both electrical contacts 11, 12 move relative to the circuit breaker housing 13. In the latter case, it is preferred that the two electrical contacts 11, 12 move in opposite directions, that is, away from one another in order to interrupt the electrical connection (toward the blocking position BP) or toward one another (in direction toward the contact position CP) in order to establish the electrical connection.

When interrupting the electrical connection by moving the electrical contacts 11, 12 away from one another and out of the contact position CP, an electrical arc may be created when the two electrical contacts 11, 12 are still positioned close to each other, particularly before reaching the blocking position BP. Such an electrical arc formation is undesired, because it still allows an electrical current to flow between the two electrical contacts 11, 12, although the electrical connection shall be interrupted. In addition, an electrical arc stresses the electrical contacts 11, 12 and causes wear, which in turn may reduce the lifetime of the circuit breaker 10. For this reason, it is desired to counteract arc formation and to terminate an electrical arc that has potentially been produced as quickly as possible.

For cooling the first electrical contact 11 in the region of its outer contact surface 14 and/or a distal end 16 of first electrical contact 11, where arc formation may occur, at least one gas flow opening 24 is provided in the area of the distal end 16 of the first electrical contact 11 or pin 20. The number of gas flow openings 24 can vary and can be defined depending on the application and the configuration of the circuit breaker 10. A multiplicity of gas flow openings 24 can be provided—in a shower head-like manner, so to speak. However, one single gas flow opening 24 is sufficient.

The at least one gas flow opening 24 can comprise a center opening 25 through which the first center axis C1 extends. Alternatively or additionally, the at least one gas flow opening may comprise at least one offset opening 26, arranged offset relative to the first center axis C1. The center opening 25 can have an opening axis A that is arranged parallel to or coinciding with the first center axis C1. The at least one offset opening 26 can have an opening axis A respectively, that is inclined relative to the first center axis C1. The opening axis A of each gas flow opening 24 defines the main or center direction in which a gas flow exits or enters the respective gas flow opening 24.

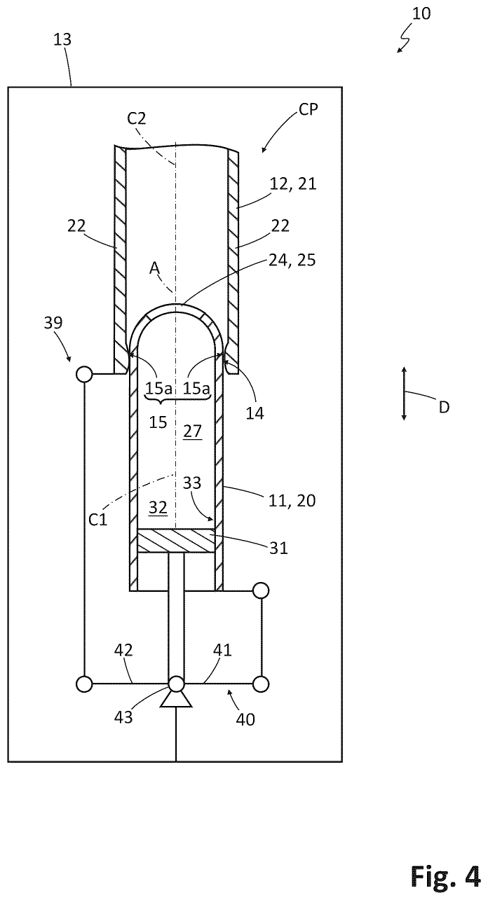

Inside the first electrical contact 11 or pin 20, an interior hollow space 27 is provided into which the at least one gas flow opening 24 opens out. This means that a fluidical connection is provided between the interior hollow space 27 and each of the at least one gas flow openings 24. The interior hollow space 27 can comprise one or more channels extending inside the first electrical contact 11 or pin 20, as illustrated in the embodiment according to FIGS. 1 and 2 by way of example. The interior hollow space 27 can alternatively or additionally comprise at least one chamber inside the first electrical contact 11 or pin 20, as for example illustrated in the embodiments according to FIGS. 4 to 7, which are described in more detail below. It has to be noted that a combination of at least one channel and at least one chamber can be provided in the first electrical contact 11 forming the interior hollow space 27. For example, at least one channel may fluidically connect an interior chamber inside the first electrical contact 11 with the at least one gas flow opening 24.

The dimension and shape of the at least one chamber and/or the at least one channel can be defined arbitrarily. For example, the at least one channel may be straight or angled or curved. Multiple fluidically connected channels may be provided intersecting one another or opening out in a common chamber of the interior hollow space 27. In this regard, many modifications of the design of the interior hollow space 27 are possible.

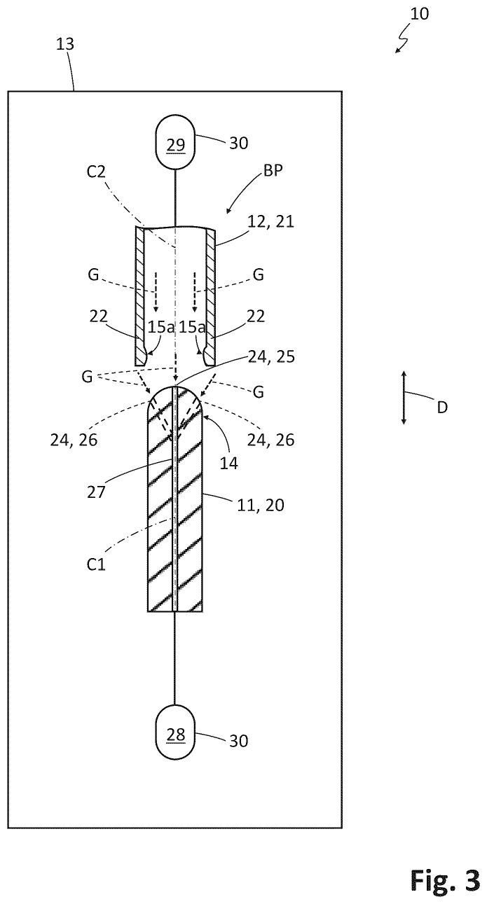

The circuit breaker 10 comprises a gas flow creating device 30. The gas flow creating device 30 is configured to create a gas flow, at least temporarily, during a separating movement between the first electrical contact 11 and the second electrical contact 12 out of the contact position CP in direction toward the blocking position BP. The gas flow can be created in a flowing direction from the interior hollow space 27 out of the at least one gas flow opening 24 or vice versa into the at least one gas flow opening 24 and further downstream into the interior hollow space 27. The flowing direction can be established in that the gas flow creating device 30 either creates a pressure inside the interior hollow space 27 above or below the pressure of the gas filling inside the circuit breaker housing 13 surrounding the first electrical contact 11 or pin 20. The alternative gas flow directions are schematically illustrated in FIGS. 2 and 3. The gas flow G is indicated highly schematically by means of dashed arrows. For creation of the gas flow G, the gas flow creating device 30 is fluidically connected to the interior hollow space 27.

In a preferred embodiment according to FIGS. 1 and 2, the gas flow creating device 30 comprises at least one gas compartment 28, 29. A first gas compartment can be assigned to the first electrical contact 11 and/or a second gas compartment 29 can be assigned to the second electrical contact 12. The two gas compartments 28, 29 can have different volumes and/or can be of different configuration.

In any embodiment, at least one of the gas compartments 28, 29 can limit a constant volume without moveable pressure increasing and/or decreasing component inside the respective gas compartment 28, 29 (particularly without a piston).

In any embodiment, at least one of the gas compartments 28, 29 can be subdivided into at least two individual compartment sections that are fluidically separable and/or connectable by means of a valve.

In any embodiment, at least one of the gas compartments 28, 29 can be provided with a pressure limiting device 35, for example a spring-loaded pressure limiting valve 36 or any suitable overpressure valve.

In the preferred embodiment the first compartment 28 that is fluidically connected—and preferably exclusively fluidically connected—to the interior hollow space 27. The gas first compartment 28 is the same gas as it is present inside the circuit breaker housing 13. The volume of the first compartment 28 is small compared to the volume of the gas present inside the circuit breaker housing 13 outside the first compartment 28 (gas filling apart from first compartment 28).

Inside the first compartment 28 no moving part (such as a piston or the like) are necessary or provided for creating the gas flow. The first compartment 28 fills with gas when the circuit breaker 10 is in the contact position CP.

In modification to the illustration on FIGS. 1 and 2, the first compartment 28 could also be provided inside the first electrical contact 11 or pin 20 and can advantageously be at least a part of the interior hollow space 27.

In all of the embodiments using a gas compartment 29 without any moving part (e.g. piston) provided therein the gas flow is exclusively produced by the pressure increase inside circuit breaker housing 13, when an electrical arc is created between the electrical contacts 11, 12. Specifically, due to the electrical arc the temperature of the gas filling rises, which in turn increases the pressure of the gas filling inside the circuit breaker housing 13.

The temperature increase due to an electrical arc also increases the gas temperature inside the first compartment 28, so that the pressure inside the first compartment 28 exceeds the pressure outside the first compartment 28, but inside the circuit breaker housing. Consequently, a gas flow G is produced out of the first compartment 28 towards and out of the at least one gas flow opening 24. Thus, no additional drive means are necessary and no energy is needed for creating the gas flow G. The energy necessary for creating the gas flow G is in this embodiment exclusively provided by the electrical arc creation as described above.

As also illustrated in FIGS. 2 and 3, as an option, the gas flow creating device 30 can be configured to create an additional gas flow toward the first electrical contact 11 or pin 20, particularly inside socket 21.

The embodiment of the circuit breaker 10 described so far operates as follows:

It is assumed that the electrical contacts 11, 12 are in the contact position CP as illustrated in FIG. 1. An electrical connection between the two electrical contacts 11, 12 is established and an electrical current may flow from the first electrical contact 11 toward the second electrical contact 12 or vice versa. In the contact position CP, the two electrical contacts 11, 12 have substantially equal electrical potentials.

If the electrical connection shall be interrupted (for example, circuit breaker 10 trips), the electrical contacts 11, 12 are moved in movement direction D out of the contact position CP in direction toward the blocking position BP. At least temporarily or preferably during the entire relative movement, the gas flow creating device 30 creates a gas flow G through the first electrical contact 11 or pin 20, that is either from the interior hollow space 27 out of the at least one gas flow opening 24 or else through the at least one gas flow opening 24 into the interior hollow space 27. Thereby, the first electrical contact 11 (here: pin 20) is cooled particularly in the region of its distal end 16 being arranged close to the second electrical contact 12. The gas flow G inside the first electrical contact 11 and the gas flow G exiting or entering the gas flow openings 24 effectively cools not only the first electrical contact 11, but also a potentially created electrical arc between the first electrical contact 11 and the second electrical contact 12. During the interruption of the electrical connection. Even though an electrical arc is created, it is therefore effectively cooled and extinguishes quickly.

When the first electrical contact 11 and the second electrical contact 12 are in the blocking position BP, the electrical arc has extinguished. In the blocking position BP, the distance between the two electrical contacts 11, 12 is sufficient to avoid that an electrical arc can be established between the two electrical contacts 11, 12.

The gas flow creating device 30 can be realized in different manners. One preferred possibility is to provide the first compartment 28 directly or indirectly fluidically connected to the at least one gas flow opening 24 as already explained with reference to FIGS. 1 and 2 above. Alternatively, the gas flow creating device 30 may use any known device for producing an over-or underpressure in the interior hollow space 27, such as a pressurizing device that can be activated if a gas flow G exiting the at least one gas flow opening 24 shall be provided or a suction unit that can be activated if a gas flow G entering the at least one gas flow opening and further flowing downstream into the interior hollow space 27 shall be created.

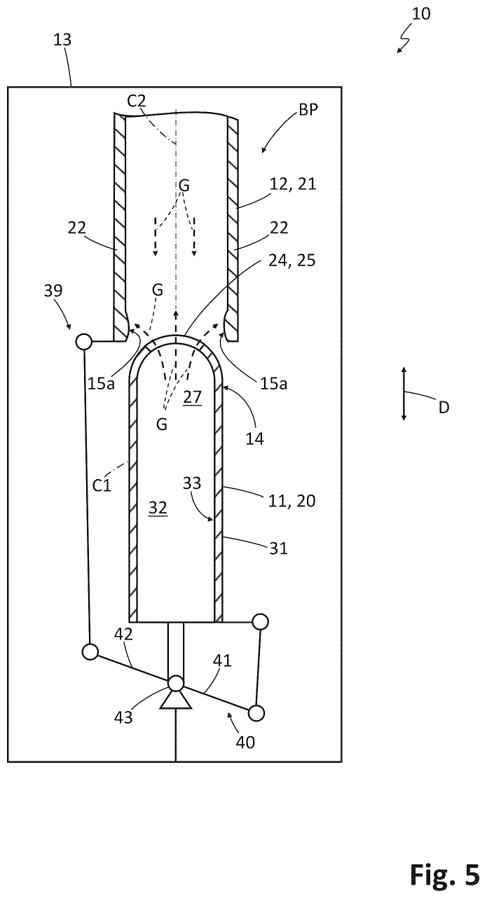

In at least one of the embodiments, the gas flow creating device 30 can be configured to create the gas flow G by means of the movement of a piston 31 (FIGS. 5 to 8). For this purpose, the piston 31 is arranged inside a cylinder chamber 32. The cylinder chamber 32 is surrounded by a cylinder chamber wall 33 being in sliding contact with the circumference of piston 31. The piston 31 and the cylinder chamber wall 33 are configured to slidingly move relative to one another, whereby the piston 31 and/or the cylinder chamber wall 33 may move relative to the circuit breaker housing 13. In the preferred embodiments, the movement direction of the relative movement between piston 31 and cylinder chamber wall 33 is parallel to the movement direction D. However, in a modified embodiment (not illustrated) the relative movement between the piston 31 and the cylinder chamber wall 33 may also have an orientation different to the movement direction D.

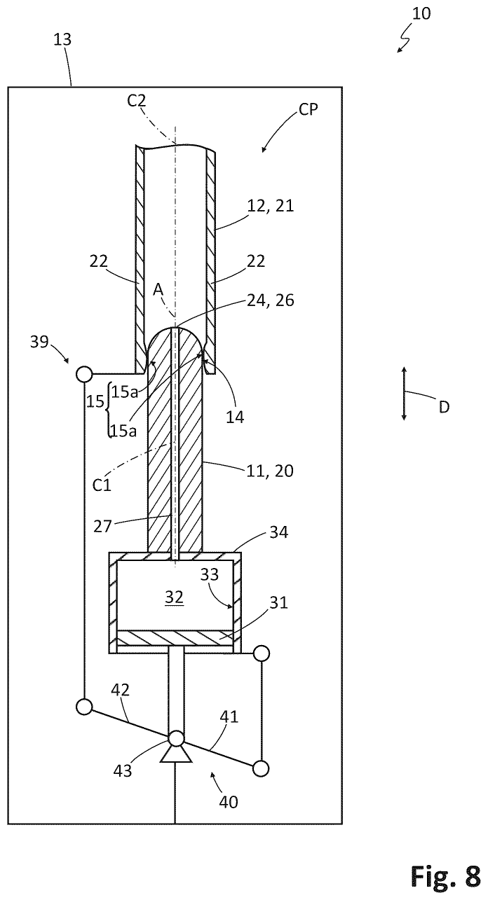

As schematically illustrated in FIGS. 5 to 7, the cylinder chamber 32 can be arranged inside the first electrical contact 11 or pin 20 and can be particularly formed by at least one section of the interior hollow space 27. Alternatively, a separate cylinder housing 34 can be provided that limits the cylinder chamber 32 (FIG. 8). The cylinder housing 34 is preferably attached to the first electrical contact 11 and further preferably in a manner that the first electrical contact 11 and the cylinder housing 34 are immovable relative to one another and can be arranged stationary relative to the circuit breaker housing 13 or can form a common unit movably arranged relative to circuit breaker housing 13.

In all of the embodiments the contact parts or contact surfaces of the cylinder chamber wall 33 and/or the piston 31 can comprise a layer or can consist of a low-friction material.

For producing a gas flow G, a movement of the piston 31 inside cylinder chamber 32 is required. This movement can be created by using a coupling arrangement 39. The coupling arrangement 39 is configured to provide a mechanical coupling between at least two movable components, whereby the movable components in any of the disclosed embodiments are selected from the following group: The first electrical contact 11, the second electrical contact 12, and a movable component of the gas flow creating device 30, according to the example, preferably the piston 31 and/or the cylinder chamber wall 33 and/or the cylinder housing 34.

Please note that in some embodiments creating a gas flow G exiting the at least one gas flow opening 24, the movement of the piston 31 can also be supported by the increasing gas pressure inside the circuit breaker housing 13 due to the arc creation.

Examples of the coupling arrangement 39 are illustrated in a highly schematical manner in FIGS. 4 to 8. In the preferred embodiments, the coupling arrangement 39 comprises a lever 40 having a first arm 41 and a second arm 42. The lever 40 is pivotably supported by means of a pivot 43. From the pivot 43, the first arm 41 and the second arm 42 extend in different directions, for example in opposite directions. The pivot 43 is stationary relative to the circuit breaker housing 13. The first arm 41 of lever 40 is coupled with the first electrical contact 11, while the second arm 42 is coupled with second electrical contact 12.

In the embodiment shown in FIGS. 4 and 5, the piston 31 is arranged stationary relative to pivot 43 and thus stationary relative to circuit breaker housing 13.

In the preferred embodiments, due to the coupling arrangement 39, the first electrical contact 11 and the second electrical contact 12 always move opposite to one another, if one of the electrical contacts is moved in moving direction D. In the embodiments having a stationary piston 31 the cylinder chamber wall 33 moves together with the first electrical contact 11 and thus relative to piston 31, if the second electrical contact 12 is moved in movement direction D. If the electrical contacts 11, 12 are moved toward the contact position CP (FIG. 4), the movement of piston 31 relative to the first electrical contact 11 and the cylinder chamber wall 33 creates a gas flow through the at least one gas flow opening 24 into the interior hollow space 27 while a movement of the electrical contacts 11, 12 in opposite direction toward the blocking position BP (FIG. 5) creates a gas flow G out of the interior hollow space 27 and out of the at least one gas flow opening 24.

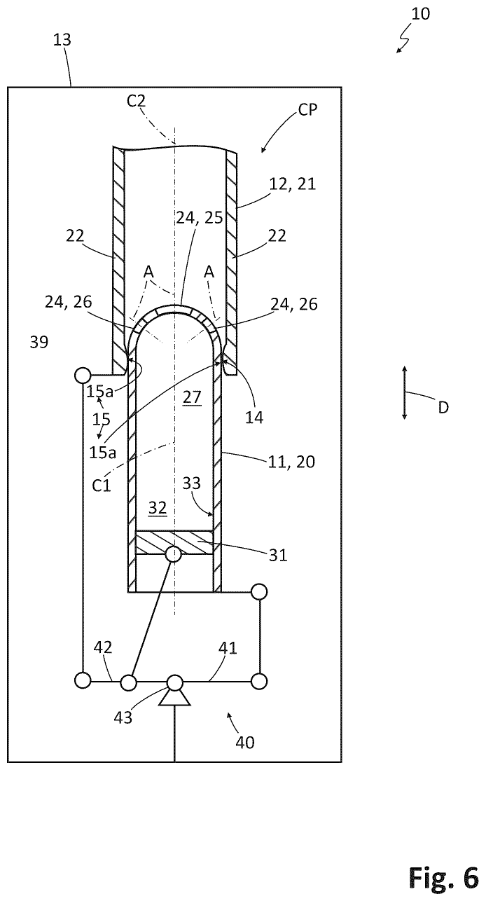

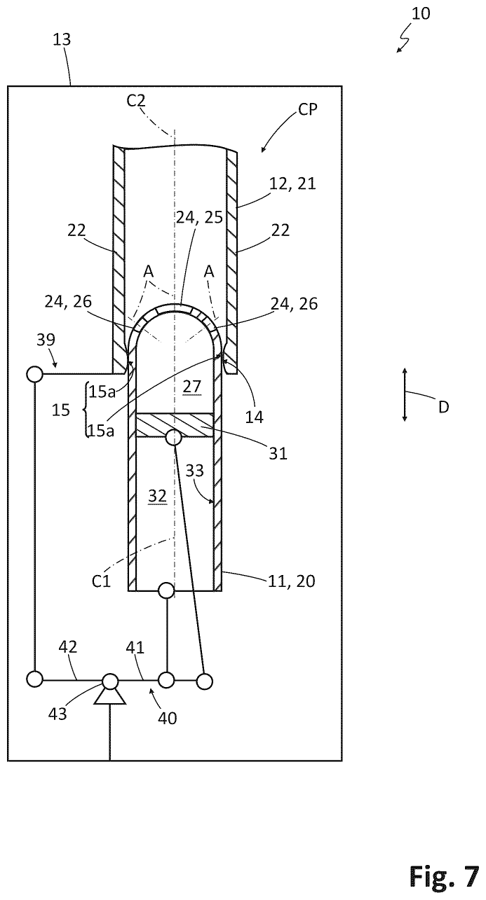

In modification to the embodiment according to FIGS. 4, 5 and 8, piston 31 can be movably arranged relative to pivot 43 and thus relative to the circuit breaker housing 13 in the embodiments shown in FIGS. 6 and 7. For this purpose, piston 31 is coupled with at least one of the electrical contacts 11, 12 by means of coupling arrangement 39 and in the present example coupling arrangement 39 couples all three movable components with one another, i.e. first electrical contact 11, second electrical contact 12 and piston 31.

In the embodiment shown in FIG. 6 piston 31 is coupled with second arm 42 of lever 40, so that piston 31 moves in the same direction as second electrical contact 12. Thus, piston 31 moves always opposite to first electrical contact 11 and thus opposite to the cylinder wall 33.

In the embodiment shown in FIG. 7 piston 31 is coupled with first arm 41 of lever 40, so that first electrical contact 11 and piston 31 move in the same direction. In order to guarantee relative movement of piston 31 and cylinder chamber wall 33, the coupling locations of piston 31 on one hand and first electrical contact 11 on the other hand with first arm 41 have to be arranged with distance to one another at first arm 41. The longer the distance the coupling location from the pivot 43 is, the longer the path that the respective coupled component 31 or 11 travels when lever 40 pivots around pivot 43. In the example shown in FIG. 7 the travel path of piston 31 is longer than the travel path of first electrical contact 11. If desired, the coupling location of the piston 31 and the lever 40 could also be provided between pivot 43 and the coupling location of the first electrical contact with first arm 41, so that the travel path of piston 31 is shorter than the travel path of first electrical contact 11 in movement direction D.

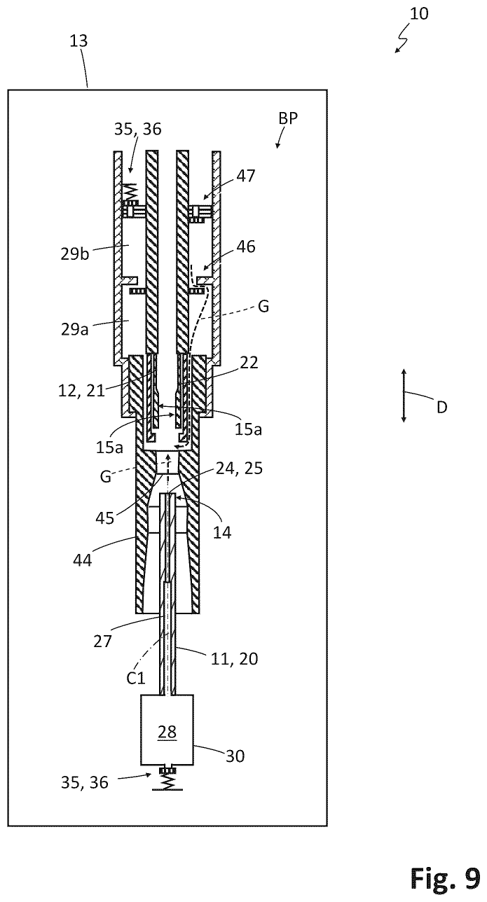

FIG. 9 depicts an embodiment of a circuit breaker 10 schematically in which more details of a specific realization are shown. Features disclosed in the embodiment according to FIG. 9 can be used in any other embodiment of the present invention.

As illustrated, the first gas compartment 28 limits a constant gas volume and does not contain movable or displaceable components for increasing or decreasing the volume, such as a piston or the like. Assigned to the first gas compartment 28 is a pressure-limiting device 35 for limiting the pressure inside the first gas compartment 28. The pressure-limiting device 35 can comprise a pressure-limiting valve 36. The pressure-limiting valve 36 can be spring-loaded and can open a gas path from the first gas compartment 28 into the volume of the circuit breaker housing 13 in case the pressure inside first gas compartment 28 exceeds a pressure threshold. Such a pressure-limiting device 35 can be provided in any embodiment of the present invention.

Another optional feature that can be provided in any embodiment of the present invention is the configuration of the interior hollow space 27. It can be realized as a channel fluidically connecting the first gas compartment 28 with the at least one gas flow opening 24, wherein the channel has sections of different cross-sectional area, particularly of different diameter in case the cross-section is circular. As shown in FIG. 9, the cross-section area of a first channel section adjoining the gas flow opening 24 is smaller than the cross-section area of a channel section adjoining the first gas compartment 28. In FIG. 9 two channel sections having different cross-section areas are illustrated. In general, two or more than two channel sections may be provided that have different cross-section areas.

In modification to the illustrated embodiment the cross-section area of the channel or hollow space 27 may vary in a step-like manner as illustrated in FIG. 9 or alternatively or additionally in a stepless manner, for example continuously. For example, the interior hollow space 27 may taper preferably by providing at least one conical section, particularly conical channel section.

In all of the embodiments, it can be advantageous if the cross-section area of the interior hollow space 27 decreases in one or more steps or decreases continuously in direction toward the gas flow opening.

The circuit breaker 10 can comprise at least one outer part 44 surrounding the first and/or second electrical contacts 11, 12 at least partly and limiting the fluid path between the two electrical contacts 11, 12. The at least one outer part 44 provides a section of the fluid path where the cross-section area is reduced compared with other sections of the gas flow path, thereby forming a nozzle 45. Such a nozzle can be provided in any embodiment of the invention.

Another optional configuration depicted in FIG. 9 is related to the second gas compartment 29. The second gas compartment 29 is here separated into at least two compartment sections and specifically in a first compartment section 29a and a second compartment section 29b. The two compartment sections can be fluidically connected with one another or fluidically separated from one another by means of a valve unit 46.

In the preferred embodiment, the valve unit 46 establishes the fluid connection between the two compartment chambers 29a, 29b, if the pressure in the first compartment section 29a is below a predefined pressure threshold. However, if the pressure in the first compartment section 29a reaches or exceeds this predefined pressure threshold, the fluid connection between the two compartment sections 29a, 29b is interrupted or blocked. This means in case of a pressure below the pressure threshold, gas G may flow from the second compartment section 29b into the first compartment section 29a and therefrom downstream toward the region, where an arc creation may occur between the first electrical contact 11 and the second electrical contact 12 (schematically illustrated by means of dashed arrow in FIG. 9). In this condition, a piston arrangement 47 can be used to create the required pressure in the second compartment section 29b. If necessary or advantageous, a pressure-limiting device 35, particularly a pressure-limiting valve 36, can be provided at the second compartment section 29b similar to the pressure-limiting device 35 described in relation to the first gas compartment 28 above.

In general, a gas compartment of any embodiment can be configured similar to the second gas compartment 29 described in FIG. 9.

The present invention refers to circuit breaker 10 comprising a first electrical contact 11 and a second electrical contact 12 that are arranged movably relative to one another in a movement direction D. Preferably, the first electrical contact 11 is a pin 20 and second electrical contact 12 is a socket 21. In a contact position CP an outer contact surface 14 of first electrical contact 11 is in mechanical and electrical contact with an inner contact surface 15 of second electrical contact 12. Inside the first electrical contact 11 an interior hollow space 27 is provided that is in fluidic connection with at least one gas flow opening 24 provided in the area of a distal end 16 of first electrical contact 11. The interior hollow space 27 is in fluidic connection with a gas flow creating device 30. During a relative movement of the first electrical contact 11 and the second electrical contact 12 in movement direction D a gas flow G may be created through the interior hollow space 27 and the at least one gas flow opening 24 for cooling at least the distal end 16 of first electrical contact 11 in order to avoid creation of an electrical arc between the two electrical contacts 11, 12 or at least terminate the electrical arc as quickly as possible.

### List of Reference Signs:

10 circuit breaker
11 first electrical contact
12 second electrical contact
13 circuit breaker housing
14 outer contact surface
15 inner contact surface
15a inner contact surface section
16 distal end of first electrical contact
20 pin
21 socket
22 contact element
24 gas flow opening
25 center opening
26 offset opening
27 interior hollow space
28 first gas compartment
29 second gas compartment
29a first compartment section
29b second compartment section
30 gas flow creating device
31 piston
32 cylinder chamber
33 cylinder chamber wall
34 cylinder housing
36 pressure limiting valve
39 coupling arrangement
40 lever
41 first arm
42 second arm
43 pivot
44 outer part
45 nozzle
46 valve unit
47 piston arrangement
OA opening axis
C1 first center axis
C2 second center axis
BP blocking position
CP contact position
D movement direction
G gas flow

We claim:

1. A circuit breaker comprising a first electrical contact having an outer contact surface, a second electrical contact having an inner contact surface and a gas flow creating device;
wherein the first electrical contact and the second electrical contact are moveably supported relative to one another in a movement direction between a contact position and a blocking position;
wherein in the contact position the inner contact surface of the second electrical contact is in contact with the outer contact surface of the first electrical contact;
wherein in the blocking position the inner contact surface of the second electrical contact and the outer contact surface of the first electrical contact are arranged with distance to one another; and
wherein the first electrical contact comprises an interior hollow space and at least one gas flow opening provided at a distal end of the first electrical contact and opening out into the interior hollow space, and that the gas flow creating device is fluidically connected with the at least one gas flow opening via the interior hollow space.

2. The circuit breaker according to claim 1, wherein the gas flow creating device comprises at least one gas compartment.

3. The circuit breaker according to claim 2, wherein one gas compartment is fluidically connected to the hollow space or is part of the hollow space and wherein the gas compartment is fluidically connected to the at least one gas flow opening.

4. The circuit breaker according to claim 2, wherein at least one of the gas compartments limits a constant volume and does not comprise moveable volume changing components.

5. The circuit breaker according to claim 1, wherein the first electrical contact is a pin.

6. The circuit breaker according to claim 1, wherein the second electrical contact is a socket.

7. The circuit breaker according to claim 1, wherein the first electrical contact extends along a first center axis and the second electrical contact extends along a second center axis, and wherein the first center axis and the second center axis are orientated parallel to the moving direction.

8. The circuit breaker according to claim 7, wherein the at least one gas flow opening comprises a center opening through which the first center axis extends.

9. The circuit breaker according to claim 7, wherein the at least one gas flow opening comprises at least one offset opening that is arranged with distance to the first center axis.

10. The circuit breaker according to claim 9, wherein the orientation of an opening axis of the at least one offset opening is inclined relative to the first center axis.

11. The circuit breaker according to claim 1, wherein the gas flow creating device is configured to create a gas flow from the interior hollow space out of the at least one gas flow opening; and/or wherein the gas flow creating device is configured to create a gas flow through the at least one gas flow opening into the interior hollow space.

12. The circuit breaker according to claim 1, wherein the gas flow creating device comprises a cylinder chamber in which a piston is arranged, wherein the cylinder chamber and the piston are movable relative to each other.

13. The circuit breaker according to claim 12, wherein at least a section of the interior hollow space forms the cylinder chamber.

14. The circuit breaker according to claim 12, wherein the cylinder chamber is arranged in a cylinder housing outside the interior hollow space and fluidically connected with the interior hollow space.

15. The circuit breaker according to claim 1, further comprising a coupling arrangement that couples at least two movable components with each other so that a movement of one of the movable components creates a movement of the at least one another movable component, wherein the at least two movable components are selected from the following components: the first electrical contact, the second electrical contact, and a movable component of the gas flow creating device.

16. The circuit breaker according to claim 15, wherein the coupling arrangement couples at least two of the following components with each other: the first electrical contact, the second electrical contact, and the piston.

17. The circuit breaker according to according to claim 15, wherein the coupling arrangement is configured so that the first electrical contact and the second electrical contact move in opposite directions.

18. The circuit breaker according to according to claim 16, wherein the coupling arrangement is configured, so that:
(i) the piston is stationary relative to a circuit breaker housing (13); or
(ii) the piston and the first electrical contact move in the same direction with different path lengths; or
(iii) the piston and the first electrical contact move in opposite directions.

19. The circuit breaker according to claim 1, further comprising a pressure limiting device such as a spring-loaded pressure limiting valve.

20. The circuit breaker according to claim 1, further comprising a nozzle in the gas flow path between the first electrical contact and the second electrical contact.
